(19) United States
(12) Patent Application Publication
(10) Pub. No.: US 2021/0394403 A1
(43) Pub. Date: Dec. 23, 2021

(54) LARGE CAPACITY ROTATIONAL MOLDING MACHINE

(71) Applicants: ZACH RANCK, Stephens City, VA (US); Billy Thurmon, Monroe, LA (US)

(72) Inventors: ZACH RANCK, Stephens City, VA (US); Billy Thurmon, Monroe, LA (US)

(21) Appl. No.: 17/355,902

(22) Filed: Jun. 23, 2021

Related U.S. Application Data
(60) Provisional application No. 63/042,657, filed on Jun. 23, 2020.

(51) Int. Cl. B29C 41/06

(52) U.S. Cl. CPC B29C 41/06

(57) ABSTRACT

A two-axis rotational thermoplastic molding apparatus is described with a U-shaped major axis arm, a circular frame formed at the open end of the major axis, and a minor axis frame mounted to the circular frame, wherein the circular frame comprises a plurality of three-sided wheel blocks comprising bearings for rotating the minor axis frame within the major axis arm. The circular frame also comprises a plurality of mounting plates enabling mold containers of varying sizes to be mounted within the minor axis frame using a corresponding frame without fully disassembling the molding apparatus. The major axis arm is mounted atop a lower frame which acts as a skid to convey the molding apparatus into and out of an oven, where the simultaneous rotation along two axes enables thermoplastic material to form according to the interior of mold container when the apparatus is under heat.

### REFERENCE TO RELATED APPLICATIONS

This application claims priority to U.S. Provisional Application No. 63/042,657, filed 23 Jun. 2020, having the title “Large Capacity Rotational Molding Machine.” The full contents of the above-reference provisional are incorporated herein by reference.

### FIELD

Embodiments usable within the scope of the present disclosure relate, generally, to a machine and system for rotational molding of thermoplastic containers (e.g., storage tanks) comprising a hexagonally braced frame for increased weight capacity, a modular plating system for quick changing molds within the machine, and improved wheel bearings for easier maintenance and performance under load.

### BACKGROUND

Generally, bulk storage tanks and other high-capacity plastic containers (on the order of 10,000-15,000 gallons) are manufactured via a “roto-molding” method. This involves enclosing a quantity of melted plastic within a mold, and subsequently rotating it under high temperature such that the inside of the mold is coated according to the desired dimensions and shape of the container to be molded.

In order to manufacture these storage tanks at scale, large capacity machines are constructed having the capability to rotate the molds on at least a major and minor axis to ensure the entirety of the mold interior is sufficiently coated. These machines are required to steadily rotate under extremely high temperature conditions for long periods of time to ensure quality.

As a result, roto-molding machines are often limited by several factors: the total weight capacity of the roto-mold machine to maintain rotation in both axes, the difficulty in quickly changing molds out in order to carry out multiple molding jobs, and the need for constant maintenance of the machine due to the stressful conditions of the oven.

The invention, embodiments of which are described herein, improves these limitations and meets the need for a roto-molding machine having a high weight capacity, modular molding attachments, and unique wheel bearings to meet the needs of roto-mold manufacturers.

### BRIEF DESCRIPTION OF THE DRAWINGS

In the detailed description of the embodiments, presented below, reference is made to the accompanying drawings:

FIGS. 1A-1B are external depictions of an embodiment of the system showing the rotational action of the various frames and components.

FIGS. 2A-2C are a side, top, and perspective view of the system in schematic form.

FIGS. 3A-3C are a side, perspective, and plan view of an embodiment of a minor axis cage formed by the major axis frame of an embodiment of the system.

FIGS. 4A-4C are a schematic view of an embodiment of quick-change mount for use with the minor axis frame of an embodiment of the system.

FIGS. 5A-5D are views and cross-sections of an embodiment of a wheel bearing for use with the major axis arm and minor axis frame of the present invention.

FIGS. 6A-6E are top, side, plan, and perspective views of an embodiment of a wheel block housing a plurality of the wheel bearings shown in FIGS. 5A-5D for rotation of the system as shown in FIGS. 1A-1B.

One or more embodiments are described below with reference to the listed Figures.

### DETAILED DESCRIPTION OF THE EMBODIMENTS

Before describing selected embodiments of the present disclosure in detail, it is to be understood that the present invention is not limited to the particular embodiments described herein. The disclosure and description herein is illustrative and explanatory of one or more presently preferred embodiments and variations thereof, and it will be appreciated by those skilled in the art that various changes in the design, organization, order of operation, means of operation, equipment structures and location, methodology, and use of mechanical equivalents may be made without departing from the spirit of the invention.

As well, it should be understood the drawings are intended to illustrate and plainly disclose presently preferred embodiments to one of skill in the art, but are not intended to be manufacturing level drawings or renditions of final products and may include simplified conceptual views as desired for easier and quicker understanding or explanation. As well, the relative size and arrangement of the components may differ from that shown and still operate within the spirit of the invention.

Moreover, it will be understood that various directions such as “upper,” “lower,” “bottom,” “top,” “left,” “right,” and so forth are made only with respect to explanation in conjunction with the drawings, and that the components may be oriented differently, for instance, during transportation and manufacturing as well as operation. Because many varying and different embodiments may be made within the scope of the concept(s) herein taught, and because many modifications may be made in the embodiments described herein, it is to be understood that the details herein are to be interpreted as illustrative and non-limiting.

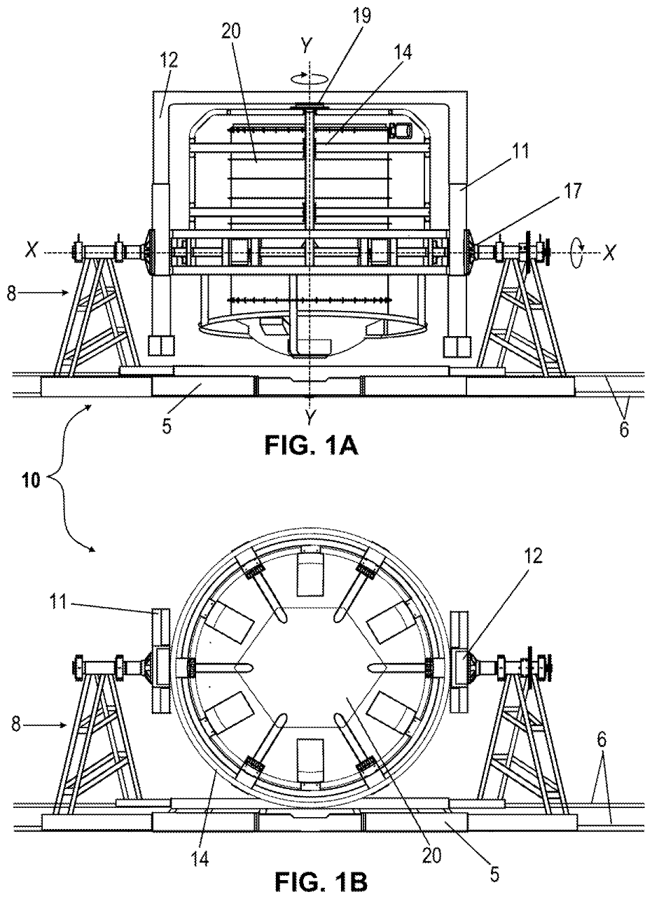

Turning first to FIGS. 1A-1B, the figures depict an embodiment of the system 10 show the rotational action of the rota-molding process. System 10 comprises a U-shaped major axis arm 12 which rotates about in the horizontal or “X” axis, driven by major axis motor 17. The major axis arm 12 houses a minor axis frame 14 which rotates about the vertical or “Y” axis, driven by minor axis motor 19. Minor axis frame 14 in turn houses a mold 20. FIG. 1A shows the major axis arm 12 and minor axis frame 14 holding the mold 20 in an upwards-facing position, with the rotation of the X and Y axes relative to the position in FIG. 1A illustrated along with the axes themselves.

The entire system 10 can be held on a lower frame 5, which can be operatively connected to conveying tracks 6 to allow insertion and withdrawal from a suitable industrial oven or other large-scale heated space. The lower frame 5 comprises two raised ends 11 mounted onto the X axis via support brackets 8, which receive each end of the major axis arm 12 attached therethrough (i.e., defining the “X” axis). The depicted embodiment is shown with the lower frame 5 and support brackets 8 on a linear rail, although it can be appreciated that other conveyers may be used within the scope of this disclosure.

FIG. 1B depicts the major axis arm 12 rotated 90 degrees, such that the open end of the U-shaped major axis arm 12 and bottom of the mold 20 in FIG. 1A now face outward towards the viewer. The rotations occur simultaneously, so the view of the mold 20 in FIG. 1B has also been rotated on the Y axis (which in the perspective of FIG. 1B extends through the bottom of the mold 20 towards the viewer).

As the system 10 is directed primarily towards the manufacture of large fluid tanks, the molds are generally of a large, vertical, cylindrical shape, with the X axis extending horizontally through the center of the mold while the Y axis extends vertically through the centerline, although it can be appreciated that the molding technique would also apply to other molds of varying sizes and shapes as long as manufacturing requires a three-dimensional interior space to be coated.

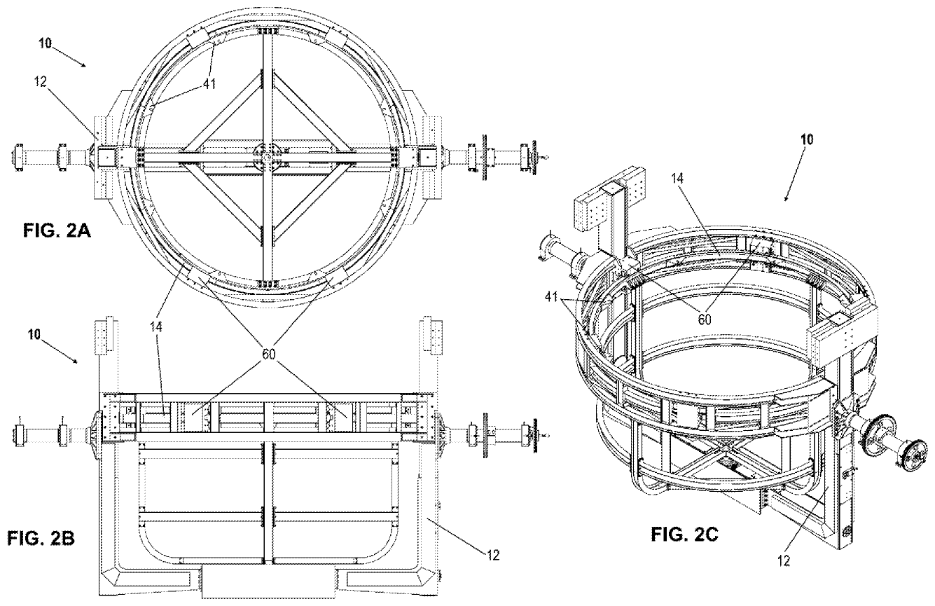

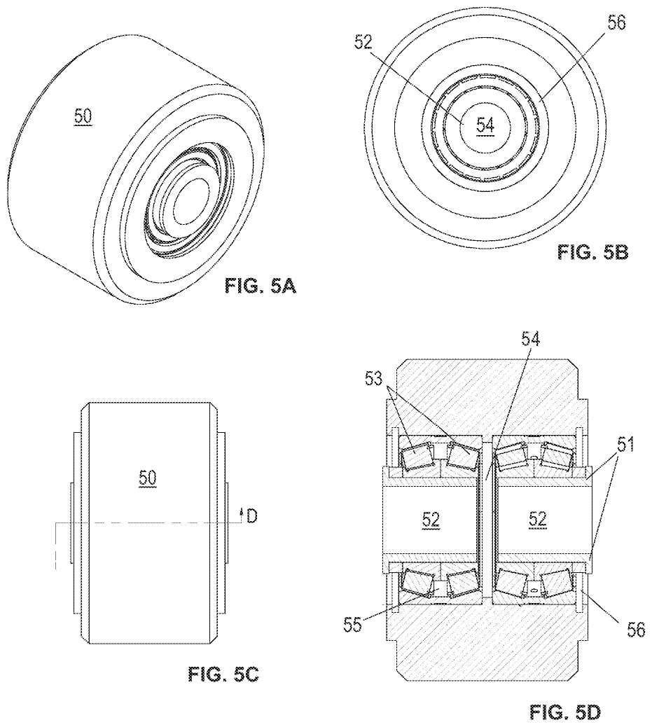

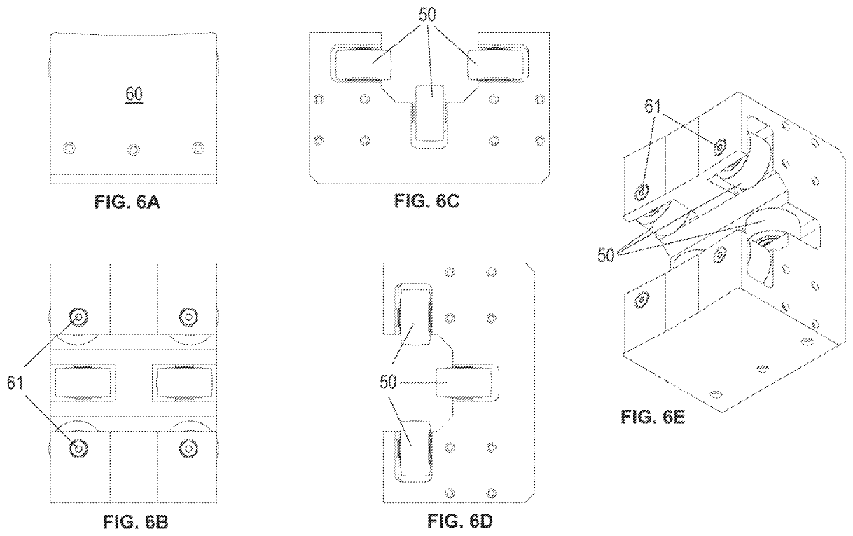

Turning now to FIGS. 2A-2C, a schematic view of the major axis arm, minor axis arm, and various supporting frameworks are shown in a top view, side view, and perspective view. The major axis arm 12 and minor axis frame 14 are attached to each other via a plurality of wheel blocks 60 (depicted in more detail in FIGS. 5A-6E) which grip a ring-shaped portion of the minor axis frame on three sides with wheel bearings, rotating the minor axis frame 14 within the major axis arm 12. The depicted embodiment is shown with a total of six wheel blocks 60; only two are labeled for clarity and it can be appreciated that other embodiments may have more, or less.

Within the minor axis frame 14 are a plurality of mounting plates 41 which receive the mold 20. The embodiment depicted here comprises a total of eight mounting plates 41; as with the wheel blocks 60, these may be increased or reduced depending on the size of the rotating mold and the requirements.

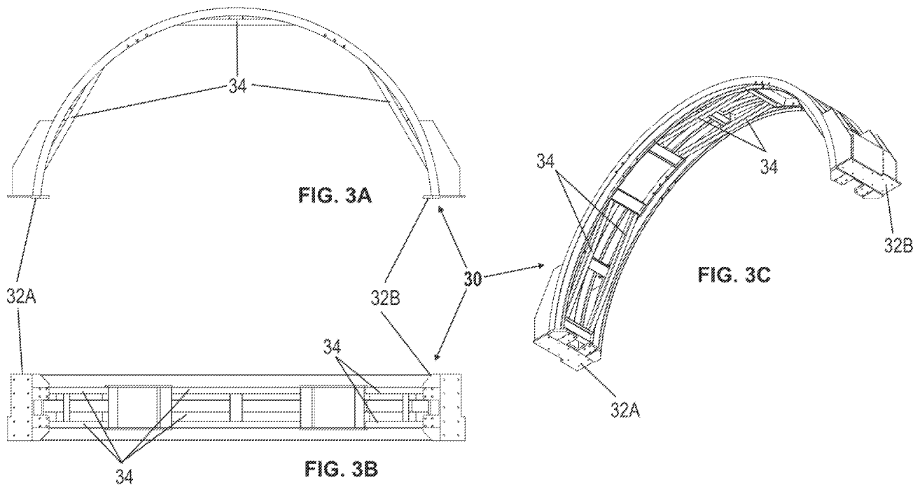

Turning now to FIGS. 3A-3C, a schematic view of a component of an embodiment of the major axis arm 12 is shown in greater detail, with wheel blocks 60 omitted for clarity (their mounting positions are still visible in FIGS. 3B-3C). As shown, the open end of the major axis arm 12 comprises two semi-circular brackets 30 which pair at both ends 32A and 32B to form a circular portion of the minor axis frame 14. In order to stiffen the open end of the major axis arm 12 against the extreme weight of the full mold 20, each bracket 30 further comprises a plurality of straight braces 34 which act as trusses to brace the circular shape of the minor axis frame 14 against deformation and warping.

The depicted embodiment of the major axis arm 12 is shown having a double hexagonal configuration (that is, with each semi-circular mounting bracket 30 comprising six braces, arranged in pairs to define three sides of a hexagonal shape). It can be appreciated that other polygonal shapes may be utilized depending on the size of the apparatus and the desired weight capacity (e.g., other embodiments may comprise an octagonal configuration) or the numbers of braces may be varied as needed (e.g., the braces may be tripled such that each side of the polygonal shape is defined by three braces instead of two).

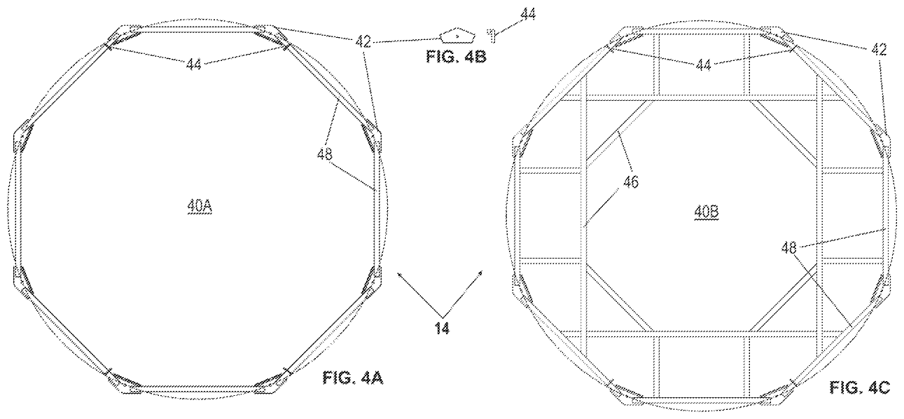

Turning now to FIGS. 4A-4C, a view of the top 40A and bottom 40B of a quick-change framework for the minor axis frame 14 is shown. As shown, the quick-change framework comprises a plurality of mounting plates 42 which correspond to the mounting plates 41 on the minor axis which are shown in FIG. 2C. The mounting plates 42 each comprise an anchor point which form a perimeter or bolt circle (indicated by the dotted lines in FIGS. 4A and 4C) representing the maximum mold capacity of the minor axis frame 14. Mounting plates 42 are welded into a series of rectangular tubes or bars 48 which form an outer framework defining a reinforced perimeter permitting molds to be attached to the quick-change framework. The quick-change framework also comprises a plurality of lifting lugs 44 which are shown in detail in FIG. 4B.

Additionally, the bottom 40B of the quick-change framework comprises additional tubing 46 defining an inner framework and an inner perimeter. In an embodiment, the inner framework 46 may be further infilled by a mesh grating (not shown) defining a walkway for operators to easily walk around between the outer and inner perimeters while mounting and dismounting a mold.

In an embodiment, the top 40A and bottom 40B of the quick-change framework can be attached to a mold 20 by welding. The mold 20 can then be lowered in and out of the minor axis frame 14 through the open end of the major axis arm 12 by means of the lifting lugs 44. Once in place, the mounting plates 41 (on the minor axis frame) and 42 (on the quick-change framework) can be bolted together easily to secure and subsequently loosen the mold 20 to the minor axis frame 14.

While the embodiment shown comprises a total of sixteen mounting plates 42 (eight on each end, with their respective rectangular bars 48 forming an octagonal shape), and eight lifting lugs 44 (four each on the top and bottom), as with the major axis arm 12, it can be appreciated that more or less mounting plates may be utilized to define a shape with more or less rectangular bars while remaining within the scope of the present disclosure.

Turning now to FIGS. 5A-5D, a wheel bearing system is shown for guiding the rotation of the minor axis frame 14 within the cage frame 30 of the major axis arm 12. In an embodiment, a wheel bearing 50 is shown housing an orifice 52 which is defined by bushings 51. An integral space 54 can extend past the bushing 51 and into the sides of the wheel; in use, this integral space 54 can act as a pocket for lubrication enabling a wheel axle (not shown for clarity) to extend through the orifice 52 and integral space 54 to receive lubrication from the pockets of integral space 54 as it rotates. FIG. 5D shows the wheel bearing system in cross section along the D axis depicted in FIG. 5C. As shown, the wheel bearing system comprises a plurality of tapered roller bearings 53 located on either side of the axle orifice 52 behind bushings 51, as well as a plurality within the bearing pocket 55. (In an embodiment, these bearings may be duplicated as tightly as necessary; these are simply the tapered roller bearings 53 visible in cross-section). The bearing pocket 55 containing tapered roller bearings 53 is designed according to the thermal expansion coefficient for the steel used for the bearings (in an embodiment, this is 4140 steel).

For ease of access to the bearing pockets 55, the wheel bearing system is shown fitted with a snap ring retainer 56 on either side of the wheel. Additionally, even when the snap ring retainer 56 is closed, the bearing pockets 55 are shown leaving a substantial amount of empty space, which is crucial for high heat applications where the bearings 53 may expand during operation and jam the wheels if insufficient space is allowed.

Turning now to FIGS. 6A-6E, an exemplar embodiment of a wheel bearing block 60 is shown, integrating the wheel-specific view of FIGS. 5A-5D with the overall view of FIGS. 2A-2C to show how the wheel bearings 50 guide the minor axis frame 14. Each wheel bearing block 60 can comprise six wheel bearings 50 which can be arranged in a 2×3 configuration where two wheels are placed on the top, the bottom, and the outer lateral side of the wheel block. Axles 61 occupy the axle orifice 52 depicted in FIGS. 5A-5D.

In use, the six wheels can be arranged around a space through which a circular portion of the minor axis frame 14 extends (omitted in this drawing for clarity but shown in FIGS. 2A-2C). In the depicted embodiments, a total of 36 wheels 50 and associated bearings can be used; six to a wheel block, and six wheel blocks at various points of the major axis arm 12 housing and rotating the minor axis frame 14.

Although several preferred embodiments of the invention have been illustrated in the accompanying drawings and described in the foregoing specification, it will be understood by those of skill in the art that additional embodiments, modifications and alterations may be constructed from the invention principles disclosed herein, while still falling within the scope of the disclosed invention.

1. A two-axis rotational molding apparatus comprising:
a major axis arm comprising an open end and a closed end in a “U” shape, a circular frame formed at the open end, and a plurality of wheel blocks, wherein each wheel block of the plurality of wheel blocks houses a plurality of wheel bearings disposed about the circular frame, the major axis arm being rotatable about a major axis;
a minor axis frame mounted to the circular frame of the major axis arm and comprising a plurality of truss bars, wherein the minor axis frame contacts the plurality of wheel bearings within the plurality of wheel blocks for rotation about a minor axis; and
a mold container disposed within the minor axis frame and housing a thermoplastic material,
wherein each wheel bearing of the plurality of wheel bearings comprises a plurality of tapered roller bearings disposed therein, wherein the major axis arm and the minor axis frame simultaneously rotate within the rotational molding apparatus, forming the thermoplastic material in the shape of the interior space of the mold container when the rotational molding apparatus is under heat.

2. The rotational molding apparatus of claim 1, further comprising a mounting frame attached to the mold, wherein the mounting frame comprises a first plurality of mounting plates defining a first perimeter.

3. The rotational molding apparatus of claim 2, wherein the minor axis frame comprises a second plurality of mounting plates corresponding to the first plurality of mounting plates, wherein the mold is attached to the minor axis frame by bolting the first plurality of mounting plates to the second plurality of mounting plates.

4. The rotational molding apparatus of claim 3, wherein the mounting frame further comprises an inner framework defining a second perimeter, wherein the first perimeter and second perimeter define a walkway therebetween.

5. The rotational molding apparatus of claim 1, wherein each wheel block of the plurality of wheel blocks comprises at least three wheel bearings, wherein the at least three wheel bearings contact the minor axis frame on at least three sides.

6. The rotational molding apparatus of claim 5, wherein each wheel block of the plurality of wheel blocks comprises at least six wheel bearings, wherein at least two of the at least six wheel bearings contact the minor axis frame on three sides.

7. The rotational molding apparatus of claim 1, wherein each wheel bearing of the plurality of wheel bearings comprises an orifice defined by bushings extending partially therethrough, wherein the plurality of tapered roller bearings are located behind the bushings within a bearing pocket.

8. The rotational molding apparatus of claim 7, wherein the bearing pocket is accessible by means of a snap ring retainer fitted to the outer surface of the wheel bearing.

9. The rotational molding apparatus of claim 1, wherein the bearing pocket housing the plurality of tapered roller bearings comprises empty space sufficient to accommodate thermal expansion of the plurality of tapered roller bearings.
